(19) United States
(12) Patent Application Publication
(10) Pub. No.: US 2006/0130449 A1
(43) Pub. Date: Jun. 22, 2006

(54) Vacuum cleaner dust collecting apparatus

(75) Inventors: Jung-gyun Han, Saha-gu (KR); Ji-won Seo, Jeonju-si (KR)

Correspondence Address: BLANK ROME LLP, 600 NEW HAMPSHIRE AVENUE, N.W., WASHINGTON, DC, 20037, US

(73) Assignee: SAMSUNG GWANGJU ELECTRONICS CO., LTD.

(21) Appl. No.: 11/137,506

(22) Filed: May 26, 2005

(30) Foreign Application Priority Data
Dec. 22, 2004 (KR) 2004-110059

(51) Int. Cl. B04C 3/00

(52) U.S. Cl. 55/452

(57) ABSTRACT

A dust collecting apparatus for a vacuum cleaner separates dust and liquid particles from intake air. In an embodiment, the apparatus has a cyclone body with a cylindrical part including an air inlet passage and an air outlet passage, a tapered part, and a contaminant receptacle coupled to the tapered part of the cyclone body. The tapered part has a diameter that decreases from the cylindrical part toward the contaminant receptacle. In some embodiments, a screen with holes sized to pass liquid particles is disposed inside the cyclone body, so that liquid particles and dust are separated during operation.

### CROSS-REFERENCE TO RELATED APPLICATIONS

The subject matter of this application may be related to the subject matter of the following co-pending applications: U.S. Patent application Serial No. (to be assigned), titled “Vacuum Cleaner Dust Collecting Apparatus” (Attorney Docket No. 116511-00162, claiming priority of Korean Application No. 2004-110060), and U.S. Patent application Serial No. (to be assigned), titled “Vacuum Cleaner Dust Collecting Apparatus and Method” (Attorney Docket No. 116511-00163, claiming priority of Korean Application No. 2004-110061).

This application claims the benefit of Korean Patent Application No. 2004-110059, filed Dec. 22, 2004 in the Korean Intellectual Property Office, the disclosure of which is incorporated herein by reference.

### BACKGROUND OF THE INVENTION

1. Field of the Invention

The present invention relates generally to the field of vacuum cleaners. In particular embodiments the invention relates to a vacuum cleaner dust collecting apparatus which is capable of separately collecting liquid particles and dust particles.

2. Description of the Related Art

Examples of dust collectors include dust bags and devices which rotate dust-laden air to separate the dust from the air.

Because dust bags have a limited life span, requiring frequent replacement, ‘cyclone’ dust collectors have recently become more popular.

The inventors have determined that when liquid particles are entrained in the dust-laden air during collection, they cause growth of fungus and/or germs in a dust collecting receptacle. Unpleasant odors may also occur when the liquid particles are included in the collected contaminants.

Additionally, liquid particles remaining in the air or flowing back from the collected contaminants may enter filters such as an exhaust filter, often plugging the filters. This causes a deterioration in suction force of the vacuum cleaner, and causes overload or sometimes damage to a suction motor. Therefore, there is a need for improvements in the field of vacuum cleaner dust collection.

### SUMMARY OF THE INVENTION

Accordingly, in an embodiment, there is provided a dust collecting apparatus that is highly efficient in collecting liquid particles.

Some embodiments also provide a dust collecting apparatus that prevents backflow of liquid particles once the particles are collected therein.

Selected embodiments also provide a dust collecting apparatus capable of collecting liquid particles in a place separate from dust particles.

A dust collecting apparatus of a vacuum cleaner according to an exemplary embodiment of the present invention provides a dust collecting apparatus including a cyclone body comprising a cylindrical part having an air inlet passage and an air outlet passage, a tapered part, and a contaminant receptacle disposed at the lower side of the cyclone body and coupled to the tapered part of the cyclone body. The tapered part is inclined to have decreasing inner diameter from the cylinder part toward the contaminant receptacle.

A screen may also be disposed within the cyclone body. The screen may include a screen cylinder corresponding in shape with the cylindrical part, and a tapered screen formed at a lower side of the screen cylinder and corresponding in shape with the tapered part.

A dust collecting receptacle intended primarily for dust may also be provided. The dust collecting receptacle may be disposed within the contaminant receptacle, and coupled with the tapered screen at one side. A heating member may also be disposed in or near the air inlet passage.

In an embodiment, a dust collecting apparatus includes a cyclone body having a first space and a second space. In the first space, air containing dust and liquid particles is rotated and the liquid particles are separated into the second space. A contaminant receptacle is coupled with the cyclone body and includes a liquid collecting space in which liquid particles separated from the air are collected, and a dust collecting space in which dust particles separated from the air are collected.

A screen may also be provided within the cyclone body, dividing the interior of the cyclone body into the first and the second spaces. The screen may include a plurality of liquid passing holes therein. A heating wire may also be provided. The heating wire may be disposed around the air inlet passage of the cyclone body to evaporate a part of the liquid particles contained in the intake air.

### BRIEF DESCRIPTION OF THE DRAWINGS

Various aspects and features of the present invention will be made more apparent by describing certain embodiments of the present invention with reference to the accompanying drawings, in which:

FIG. 1 is a perspective view of a dust collecting apparatus according to a first exemplary embodiment of the present invention;

FIG. 2 is a perspective view illustrating the cyclone body and dust collecting receptacle of FIG. 1 separated from each other;

FIG. 3 is a sectional view taken on line III-III of FIG. 1;

FIG. 4 is a perspective view of a dust collecting apparatus according to a second exemplary embodiment of the present invention;

FIG. 5 is a sectional view taken on line V-V of FIG. 4;

FIG. 6 is a perspective view illustrating the screen and dust collecting receptacle of FIG. 4 separated from each other; and

FIG. 7 is a view illustrating a dust collecting apparatus according to a third embodiment of the present invention.

### DETAILED DESCRIPTION OF THE PREFERRED EMBODIMENTS

Certain embodiments of the present invention will be described in greater detail with reference to the accompanying drawings.

In the following description, the same drawing reference numerals are used for the same elements even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail.

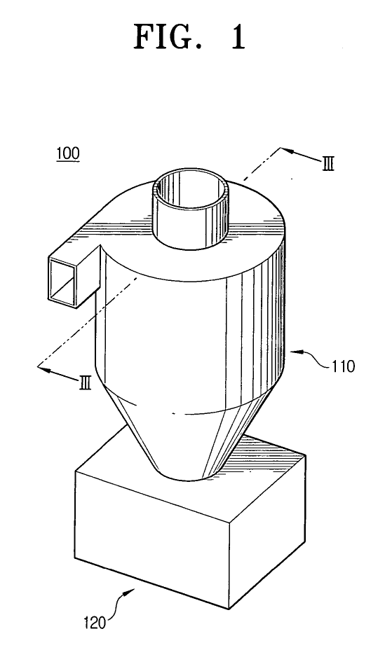

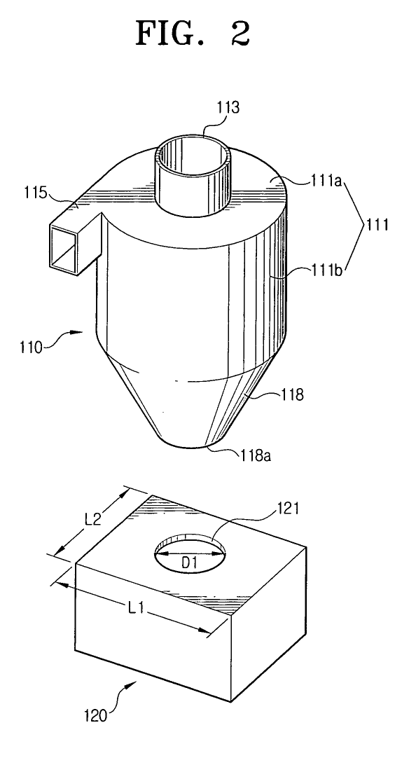

Referring to FIGS. 1 to 3, a dust collecting apparatus 100 according to an embodiment of the present invention includes a cyclone body 110 and a contaminant receptacle 120.

The cyclone body 110 has a cylinder part 111 and a tapered part 118 to separate liquid particles and dust particles from contaminant-laden air.

The cylinder part 111 is a part of the cyclone body 110. The cylinder part 111 has an air outlet passage 113 on an upper side 111a through which contaminant-free air is discharged. The air outlet passage 113 takes on the configuration of a cylindrical tube, which is welded or otherwise attached to the upper side 111a of the cylinder part 111. Alternatively, the air outlet passage 113 may be integrally formed with the cylinder part 111 by molding. Although the embodiment presented in this description describes the air outlet passage 113 as a cylindrical pipe, those skilled in the field will appreciate that this is merely an example; air outlet passage 113 may have any operational configuration, such as (for example) rectangular. Furthermore, air outlet passage 113 may be inserted a predetermined distance into the cyclone body 110 and a grill (not shown) may be provided on the inserted portion of air outlet passage 113.

Cylinder part 111 has an air inlet passage 115 formed in a circumference 111b to draw air, containing dust and liquid particles therein, into the cyclone body 110 with a centrifugal force. Air inlet passage 115 may be configured as a rectangular pipe and may be welded or otherwise attached to the circumference 111b of the cylinder part 111. The air inlet passage 115 may also be integrally formed with the cylinder part 111 by molding. Air inlet passage 115 may also have a variety of appropriate configurations other than a rectangular shape as described in the present embodiment, such as a cylindrical pipe or the like.

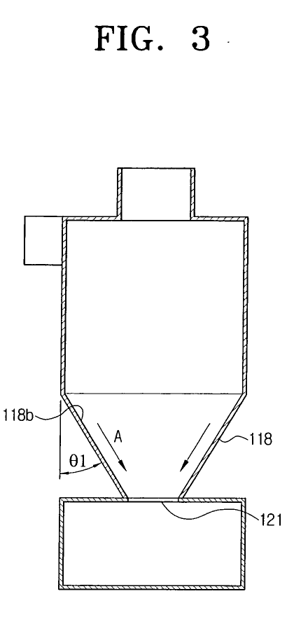

Tapered part 118 is an extended part of cyclone body 110 formed at the lower side of the cylinder part 111 and decreases in diameter toward the direction of the contaminant receptacle 120. Tapered part 118 has an outlet 118a formed at a point of minimum diameter so that dust and liquid particles can pass through outlet 118a after being separated in the cyclone body 110. Outlet 118a is connected with an inlet 121 of the contaminant receptacle 120. Referring to FIG. 3, tapered part 118 preferably has an inclination angle θ1 ranging from approximately 30 degrees to approximately 50 degrees.

Along tapered part 118, liquid particles can flow smoothly to the contaminant receptacle 120. More specifically, liquid particles separated from the intake air by centrifugal force flow along the inclined side 118b of the tapered part 118 in direction “A”. Because of tapered part 118, inlet 121 of contaminant receptacle 120 can be made small enough to prevent dust or liquid particles from flowing back once they are collected. This backflow prevention is particularly efficient for the liquid particles, which are larger than air molecules.

Contaminant receptacle 120 is a substantially rectangular container coupled to the lower side of the cyclone body 110. Dust or liquid particles are collected in the contaminant receptacle 120 when separated in the cyclone body 110. Inlet 121 is formed in the upper side of the contaminant receptacle 120 through which dust and liquid particles flow. Inlet 121 may be sized to have a diameter D1 which is smaller than horizontal and vertical lengths L1 and L2 of the contaminant receptacle 120.

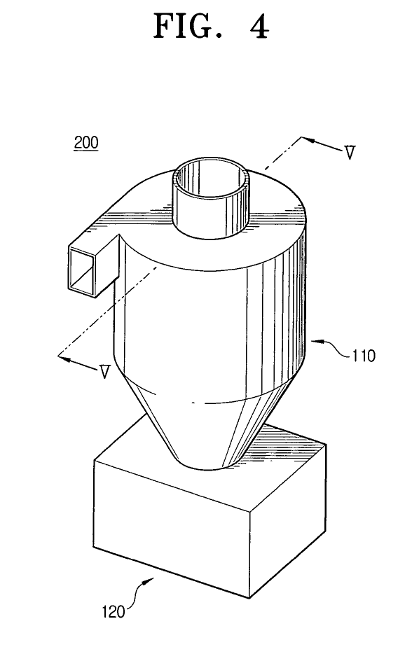

FIGS. 4 to 6 illustrate a dust collecting apparatus 200 according to a second embodiment of the present invention that prevents dust and liquid particles from mixing with each other inside the contaminant receptacle 120. In the following description, similar or identical elements to those of the first embodiment will be indicated by the same reference numerals and explanation thereof will be omitted for the purpose of brevity.

Referring to FIGS. 4 to 6, a dust collecting apparatus 200 according to the second embodiment includes a cyclone body 110, a contaminant receptacle 120, a screen 130 and a dust collecting receptacle 140.

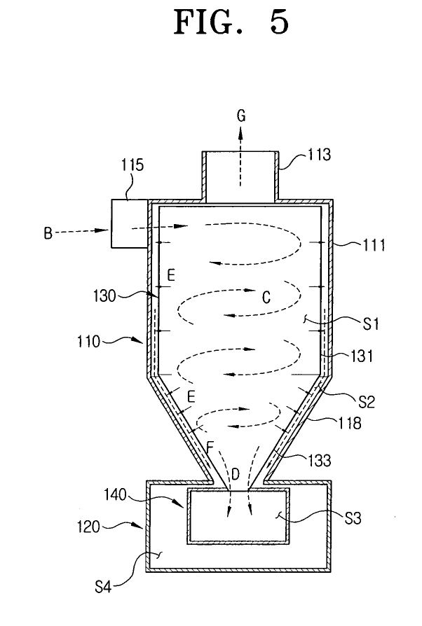

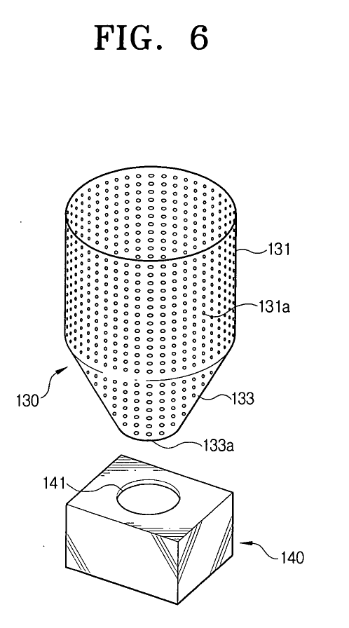

Referring to FIGS. 5 and 6, screen 130 is disposed within cyclone body 110 and has a plurality of liquid passing holes 131a. Screen 130 also divides the interior of the cyclone body 110 into first and second spaces S1 and S2, respectively.

The first space S1 is connected with air inlet passage 115. Dust and liquid particles are separated by centrifugal force in the first space S1.

When the liquid particles are separated in the first space S1, the liquid particles flow into the second space S2 through the liquid passing holes 131a. As the liquid particles are passed through the narrow liquid passing holes 131a, the liquid particles are condensed. This means that not only the large particles of liquid, but also relatively minute liquid particles can be collected by operation of liquid passing holes 131a.

The screen 130 has a screen cylinder 131 corresponding in shape with the cylindrical part 111, and a tapered screen 133 formed at the lower side of the screen cylinder 131 and corresponding to the tapered part 118.

The screen cylinder 131 is configured substantially identically to cylindrical part 111 of the cyclone body 110. However, the screen cylinder 131 has a smaller diameter than cylindrical part 111 of cyclone body 110 so as to fit inside cyclone body 110.

The tapered screen 133 has substantially the same shape as that of tapered part 118 of the cyclone body 110. However, tapered screen 133 is sized smaller than tapered part 118 so that the tapered screen 133 can be inserted in the cyclone body 110. A dust outlet 133a is formed at a portion of tapered screen 133 having the smallest diameter. The dust outlet 133a is connected with an inlet 141 of dust collecting receptacle 140.

The screen cylinder 131 and the tapered screen 133 may not necessarily take on the same configurations as those of the cylinder part 111 and the tapered part 118 of the cyclone body 110, although similar configurations are preferred to obtain higher dust or liquid separation efficiency without loss of suction force.

Based on the positioning of the screen cylinder 131 and the tapered screen 133, the first space S1 is established inside the screen 130, and the second space S2 is established between the screen 130 and the cyclone body 110.

The dust collecting receptacle 140, intended to contain primarily dust is a rectangular container which is connected with the screen 130 by one end. The dust collecting receptacle 140 is formed inside the contaminant receptacle 120. The dust collecting receptacle 140 has substantially the same configuration as that of the contaminant receptacle 120. However, the dust collecting receptacle 140 is sized smaller than the contaminant receptacle 120 so as to be inserted in the contaminant receptacle 120. A dust inlet 141 is formed in the upper side of the dust collecting receptacle 140.

If the dust collecting receptacle 140 is disposed within the contaminant receptacle 120, a liquid collecting space S4 is formed in the interval between the dust collecting receptacle 140 and the contaminant receptacle 120. The liquid collecting space S4 is connected with the second space S2. A dust collecting space S3 is also formed within the dust collecting receptacle 140. The dust collecting space S3 is connected with the first space S1.

Accordingly, dust particles are collected in the dust collecting space S3, while the liquid particles are collected in the liquid collecting space S4.

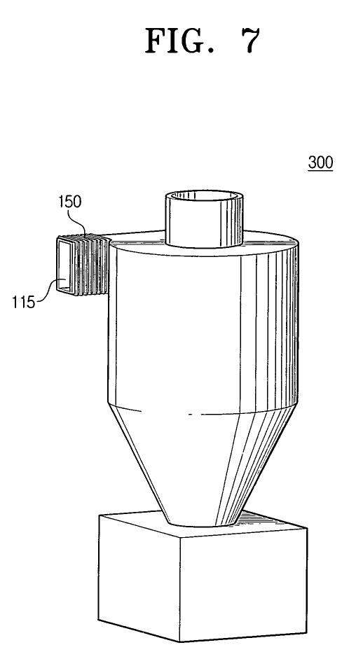

A dust collecting apparatus 300 according to a third embodiment of the present invention will now be described below with reference to FIG. 7. The similar or identical elements of the third embodiment to those of the first and second embodiments will be indicated by the same reference numerals and explanations thereof will be omitted for the purpose of brevity.

The following embodiments can be implemented in any of the dust collecting apparatus 100 and 200 of the first and second embodiments.

Referring now to FIG. 7, a heating wire 150 can be disposed in the air inlet passage 115. The heating wire 150 may be wound around the air inlet passage 115, and as the heating wire 150 heats the air inlet passage 115, liquid particles evaporate from the air as the air passes through the air inlet passage 115. Accordingly, the dust collecting apparatus 100 is burdened with fewer liquid particles.

In addition to heating wire 150 as illustrated in this embodiment, any other effective heating member such as a heating plate can be disposed to surround the air inlet passage 115. Alternatively, a heating plate may itself be formed as the air inlet passage 115.

The operation of the dust collecting apparatus 200 according to the second embodiment of the present invention will now be described.

Referring to FIGS. 5 and 6, air containing dust and liquid particles therein is drawn into the cyclone body 110 by the suction force of the vacuum cleaner (not shown) through the air inlet passage 115 in the direction of arrow “B”.

As the intake air rotates inside the first space S1 in the direction of arrow “C”, dust particles are blocked by the liquid passing holes 131a and fall in the direction of arrow “D” into dust collecting space S3.

Meanwhile, liquid particles in the intake air pass through the liquid passing holes 131a of the screen 130 in the direction of arrow “E”, flow into the second space S2, and then to the liquid collecting space S4 in the direction of arrow “F” to be collected therein.

The processed air then flows in the direction of arrow “G” through air outlet passage 113 at the upper side of the cyclone body 110, and is discharged from dust collecting apparatus 200.

The dust collecting apparatus as described above in a few exemplary embodiments of the present invention offers the following advantages:

First, the tapered design prevents backflow of liquid particles once they are collected, and therefore, blockage of the filter by backflowing liquid is prevented. Accordingly, the cleaner maintains a constant suction force and the suction motor operates without overloading.

Secondly, the presence of the screen increases collecting efficiency for liquid particles. Accordingly, filter blockage by non-separated liquid particles is prevented. The cleaner maintains a constant suction force and the suction motor operates without overloading.

Thirdly, the filter is kept dry and therefore, protected from fungus or germs. Accordingly, the design results in improved hygiene.

Fourthly, the presence of liquid particles in the collected dust is minimized, and as a result, dust does not attach to the wall of the dust collecting receptacle and is more easily discharged.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A dust collecting apparatus comprising:
a cyclone body comprising a cylindrical part having an air inlet passage and an air outlet passage, and a tapered part; and
a contaminant receptacle disposed at the lower side of the cyclone body and coupled to the tapered part of the cyclone body,
wherein the tapered part has a decreasing inner diameter from the cylindrical part toward the contaminant receptacle.

2. The dust collecting apparatus of claim 1, further comprising a screen disposed within the cyclone body.

3. The dust collecting apparatus of claim 2, wherein the screen comprises:
a cylindrical portion corresponding in shape to the cylindrical part; and
a tapered portion formed at a lower side of the cylindrical portion and corresponding in shape to the tapered part.

4. The dust collecting apparatus of claim 3, wherein the screen comprises a plurality of liquid passing holes.

5. The dust collecting apparatus of claim 2, further comprising a dust collecting receptacle which is disposed within the contaminant receptacle, and coupled with the tapered screen at one side.

6. The dust collecting apparatus of claim 1, further comprising a heating member positioned relative to the air inlet passage to heat inlet air.

7. A dust collecting apparatus comprising:
a cyclone body having a first space and a second space, configured such that in operation, air containing dust and liquid particles rotate in the first space and separated liquid particles flow to the second space; and
a contaminant receptacle coupled with the cyclone body and having a liquid collecting space in which liquid particles separated from the air are collected, and a dust collecting space in which dust particles separated from the air are collected.

8. The dust collecting apparatus of claim 7, further comprising a screen disposed within the cyclone body, dividing the interior of the cyclone body into the first and the second spaces, the screen comprising a plurality of liquid passing holes therein.

9. The dust collecting apparatus of claim 8, further comprising a heating wire which is disposed around an air inlet passage of the cyclone body to evaporate liquid particles contained in inlet air.
